(19) United States
(12) Patent Application Publication
(10) Pub. No.: US 2024/0193458 A1
(43) Pub. Date: Jun. 13, 2024

(54) QUANTUM FOURIER TRANSFORMATION CIRCUIT AND METHOD OF FORMING THE SAME

(71) Applicant: University of Seoul Industry Cooperation Foundation, Seoul (KR)

(72) Inventor: Do Yeol AHN, Seoul (KR)

(73) Assignee: University of Seoul Industry Cooperation Foundation, Seoul (KR)

(21) Appl. No.: 18/090,223

(22) Filed: Dec. 28, 2022

(30) Foreign Application Priority Data
Dec. 7, 2022 (KR) 10-2022-0169867

(51) Int. Cl. G06N 10/60; G06N 10/20; G06N 10/70

(52) U.S. Cl. CPC G06N 10/60; G06N 10/20; G06N 10/70

(57) ABSTRACT

The present invention discloses a Quantum Fourier Transformation (QFT) circuit and a method of forming the QFT circuit capable of reducing the number of T-count and T-depth. The method of forming a QFT circuit comprises moving Hadamard gate (H-gate) of an even-numbered qubits to the earliest stage where there is no quantum entanglement with other qubits, in a standard n (n is a natural number greater than or equal to 5) qubit QFT, decomposing quantum circuit into a form in which R_{z} gate is implemented, using quantum addition, and reducing a number of R_{z} gate layers using ancilla qubits.

### CROSS REFERENCE TO RELATED APPLICATION

This application claims priority from and the benefit of Korean Patent Applications No. 10-2022-0169867, filed on Dec. 7, 2022, which is hereby incorporated by reference for all purposes as if fully set forth herein.

### BACKGROUND OF THE INVENTION

### Field of the Invention

The present invention relates to a Quantum Fourier Transformation (QFT) circuit and a method of forming the QFT circuit.

### Discussion of the Background

The quantum Fourier transform (QFT) is one of the most important quantum operations for numerous quantum computing applications. The major obstacle to the construction of QFT is the large number of elementary gates needed to build the circuit. Of these resources required for the fault-tolerant implementation, the T-count and the T-depth are the major costs. Currently, the best-known representation of n-qubit QFT to the precision Q(s) shows the T-count of Snlog₂, (n/ε) and the T-depth of 2nlog₂(n/ε), respectively, which are obtained by using Toffoli gates and additions. Here, we present the new construction scheme of QFT which halves both T-count and T-depth of the best-known implementation by using quantum Karnaugh map, a general quantum circuit optimization protocol recently developed by us. It is shown that Toffoli gates that add up the half of T-counts of previous works, become unnecessary and the the number of R_{z} layers are reduced before applying addition. NISQ experiments of QFT that show the right answer by majority vote on the IonQ device using Amazon Barket are also performed.

### SUMMARY OF THE INVENTION

Therefore, the technical problem of the present invention is to provide a method of forming the QFT circuit capable of reducing the number of T-count and T-depth.

The technical problem of the present invention is to provide a QFT circuit capable of reducing the number of T-count and T-depth.

The method of forming a Quantum Fourier Transform (QFT) circuit comprises moving Hadamard gate (H-gate) of an even-numbered qubits to the earliest stage where there is no quantum entanglement with other qubits, in a standard n (n is a natural number greater than or equal to 5) qubit QFT, decomposing quantum circuit into a form in which R_{z} gate is implemented, using quantum addition, and reducing a number of R_{z} gate layers using ancilla qubits.

The form in which R_{z} gate is implemented, performs the following.

In a first step, the Hadamard gate is applied to the qo qubit, an R_{z}(π/4) gate is applied to the q1 qubit, and an R_{z}(3π/2^{k+1}) gate is applied to qₖ qubits (k is a natural number greater than or equal to 5 and less than or equal to n−1).

In a second step, a CNOT gate is applied to the q₀ gate, based on the q₁ qubit after the first step.

In a third step, an R_{z}(−π/4) gate is applied to the q₀ qubit after the second step.

In a fourth step, a CNOT gate is applied to the q₀ gate, based on the q₁ qubit after the third step.

In a fifth step, a Hadamard gate is applied to the q₁ qubit after the fourth step.

In a sixth step, a CNOT gate is applied to q₁ to q₍ₙ₋₁₎ qubits, based on the q₀ qubits after fifth step.

In a seventh step, an R_{z}(−π/2^{l+1}) gate is applied to the q₁ gate after the sixth step (1 is a natural number greater than or equal to 5 and less than or equal to n−1).

In an eighth step, a CNOT gate is applied to q₁ to q₍ₙ₋₁₎ qubits, based on the q₀ qubits after the seventh step.

In a ninth step, a CNOT gate is applied to q₂ to q₍ₙ₋₁₎ qubits, based on the q₁ qubit after the eighth step.

In a tenth step, an R_{z}(−π/2^{l}) gate is applied to the q₁ gate after the ninth step (1 is a natural number greater than or equal to 5 and less than or equal to n−1).

In eleventh step, a CNOT gate is applied to q₂ to q₍ₙ₋₁₎ qubits, based on the q₁ qubit after the tenth step.

In twelfth step, an R_{z}(15π/32) gate is applied to the q₀ qubit after the eighth step, and applying an R_{z} (7π/16) gate to the q₁ qubit after the eleventh step, wherein

$${R}_{Z} ( θ ) = {e}^{- i θ / 2} ( \begin{matrix}1 & 0 \\ 0 & {e}^{i θ}\end{matrix} )$$

The quantum circuit with reduced number of R_{z} gate layers using ancilla qubits, performs the following.

In a first step, a Hadamard gate is applied to the q₀ qubit, an R_{z}(π/4) gate is applied to the q₁ qubit, and an R_{z}(3π/2^{k+1}) gate is applied to qₖ qubits (k is a natural number greater than or equal to 5 and less than or equal to n−1).

In a second step, a CNOT gate is applied to the q₀ gate, based on the q₁ qubit after the first step.

In a third step, an R_{z}(−π/4) gate is applied to the q₀ qubit after the second step.

In a fourth step, a CNOT gate is applied to the q₀ gate, based on the qu qubit after the third step.

In a fifth step, a Hadamard gate is applied to the qu qubit after the fourth step, and a CNOT gate is applied to a third ancilla qubit |0>, based on the q₄ qubits after the first step.

In a sixth step, a CNOT gate is applied to a second ancilla qubit |0>, based on the q₃ qubit after the first step.

In a seventh step, a CNOT gate is applied to a first ancilla qubit |0>, based on the q₂ qubits after the first step.

In an eighth step, a CNOT gate is applied to the first to third ancilla qubits, based on the q₁ qubit after the fifth step.

In a ninth step, a CNOT gate is applied to q₂ to q₄ qubits, based on the q₀ qubits after the fourth step.

In a tenth step, an R_{z}(−π/8) gate is applied to the q₂ qubit, an R_{z}(−π/16) gate is applied to the q₃ qubit, an R_{z}(−π/32) gate is applied to the qu qubit, an R_{z}(−π/4) gate is applied to the first ancilla qubit, an R_{z}(−π/8) gate is applied to the second ancilla qubit, and an R_{z}(−π/16) gate is applied to the third ancilla qubit.

In an eleventh step, a CNOT gate is applied to the q₂, q₃, and q₄ qubits, based on the q₀ qubit.

In a twelfth step, a CNOT gate is applied to the first to third ancilla qubits, based on the q₁ qubit.

In a thirteenth step, a CNOT gate is applied to the first ancilla qubit, based on the q₂ qubit.

In a fourteenth step, a CNOT gate is applied to the second ancilla qubit, based on the q₃ qubit.

In a fifteenth step, a CNOT gate is applied to the third ancilla qubit, based on the q₄ qubit.

In a sixteenth step, an R_{z}(15π/32) gate is applied to the q₀ qubit, and applying R_{z}(7π/16) gate to the q₁ qubit.

The n-qubits Quantum Fourier Transform circuit that performs following steps (n is a natural number greater than or equal to 5).

In a first step, a Hadamard gate is applied to q₀ qubit, applying an R_{z}(π/4) gate to the q₁ qubit, an R_{z}(3π/2^{k+1}) gate is applied to qₖ qubits (k is a natural number greater than or equal to 5 and less than or equal to n−1).

In a second step, a CNOT gate is applied to the q₀ gate, based on the q₁ qubit after the first step.

In a third step, an R_{z}(−π/4) gate is applied to the q₀ qubit after the second step.

In a fourth step, a CNOT gate is applied to the q₀ gate, based on the q₁ qubit after the third step.

In a fifth step, a Hadamard gate is applied to the q₁ qubit after the fourth step, and a CNOT gate is applied to a third ancilla qubit |0>, based on the q₄ qubits after the first step.

In a sixth step, a CNOT gate is applied to a second ancilla qubit |0>, based on the q₃ qubit after the first step.

In a seventh step, a CNOT gate is applied to a first ancilla qubit |0>, based on the q₂ qubits after the first step.

In an eighth step, a CNOT gate is applied to the first to third ancilla qubits, based on the q₁ qubit after the fifth step.

In a ninth step, a CNOT gate is applied to q₂ to qu qubits, based on the q₀ qubits after the fourth step.

In a tenth step, an R_{z}(−π/8) gate is applied to the q₂ qubit, an R_{z}(−π/16) gate is applied to the q₃ qubit, an R_{z}(−π/32) gate is applied to the q₄ qubit, an R_{z}(−π/4) gate is applied to the first ancilla qubit, an R_{z}(−π/8) gate is applied to the second ancilla qubit, and an R_{z}(−π/16) gate is applied to the third ancilla qubit.

In an eleventh step, a CNOT gate is applied to the q₂, q₃, and q₄ qubits, based on the q₀ qubit.

In a twelfth step, a CNOT gate is applied to the first to third ancilla qubits, based on the q₁ qubit.

In a thirteenth step, a CNOT gate is applied to the first ancilla qubit, based on the q₂ qubit.

In a fourteenth step, a CNOT gate is applied to the second ancilla qubit, based on the q₃ qubit.

In a fifteenth step, a CNOT gate is applied to the third ancilla qubit, based on the q₄ qubit.

In a sixteenth step, a Hadamard gate is applied to the q₂ qubit.

In a seventeenth step, a CNOT gate is applied to the q₂ qubit, based on the q₃ qubit.

In an eighteenth step, an R_{z}(−π/4) gate is applied to the q₂ qubit.

In a nineteenth step, a CNOT gate is applied to the q₂ qubit, based on the q₃ qubit.

In a twentieth step, a Hadamard gate is applied to the q₃ qubit.

In a twenty first step, a CNOT gate is applied to the first ancilla qubit, based on the q₄ qubit.

In a twenty second step, a CNOT gate is applied to the first ancilla qubit, based on the q₃ qubit.

In a twenty third step, a CNOT gate is applied to the q₄ qubit, based on the q₂ qubit.

In a twenty fourth step, an R_{z}(−π/8) gate is applied to the q₄ qubit, and an R_{z}(−π/4) gate is applied to the first ancilla qubit.

In a twenty fifth step, a CNOT gate is applied to the q₄ qubit, based on the q₂ qubit.

In a twenty sixth step, a CNOT gate is applied to the first ancilla qubit, based on the q₃ qubit.

In a twenty seventh step, a CNOT gate is applied to the first ancilla qubit, based on the q₄ qubit.

In a twenty eighth step, an R_{z}(15π/32) gate is applied to the q₀ qubit, an R_{z}(7π/16) gate is applied to the qu qubit, an R_{z}(3π/8) gate is applied to the q₂ qubit, an R_{z}(π/4) gate is applied to the q₃ qubit, and a Hadamard gate is applied to the q₄ qubit.

In a twenty ninth step, the q₁ qubit and the q₃ qubit are swapped.

In a thirtieth step, q₀ and q₄ qubits are swapped.

In the above,

$${R}_{Z} ( θ ) = {e}^{- i θ / 2} ( \begin{matrix}1 & 0 \\ 0 & {e}^{i θ}\end{matrix} )$$

According to the QFT circuit and the method of forming the QFT circuit, T-count and T-depth can be reduced.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a conventional 5-qubit QFT circuit diagram.

FIG. 2 is a circuit diagram in which H gates of even-numbered qubits are moved to the left as far as possible in the standard QFT circuit of FIG. 1.

FIG. 3 is a part of the circuit of FIG. 2.

FIG. 4 is a circuit in which the circuit of FIG. 3 is decomposed into a form in which the R_{z} gate can be implemented using quantum addition.

FIG. 5 is a circuit configured to have reduced R_{z} gate layers in the circuit of FIG. 4 by using ancilla qubits initially in the |0>state.

FIGS. 6 to 8 are circuit identities.

FIG. 9 is a decomposed quantum Fourier transform (QFT) circuit according to an embodiment of the present invention.

FIG. 10 is a graph showing an example of a result of implementing quantum phase estimation (QPE) in an IonQ device.

FIG. 11 is a graph showing simulation results showing the number of CNOTs for a 7-qubit quantum computer using a Falcon r5.11H processor.

FIG. 12 is a graph showing simulation results showing the number of CNOTs for a 16-qubit quantum computer using a Falcon r4P processor.

FIG. 13 is a graph showing simulation results showing the number of CNOTs for a 27-qubit quantum computer using a Falcon r5.11 processor.

FIG. 14 is a graph showing simulation results showing the number of CNOTs for a 27-qubit quantum computer using an Eagle r1 processor.

FIG. 15 is a graph showing simulation results showing the number of CNOTs for 10 to 90 qubit quantum computers.

### DETAILED DESCRIPTION OF THE ILLUSTRATED EMBODIMENTS

The present invention is described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that, although the terms first, second, etc. may be used herein to describe various elements, these elements should not be limited by these terms. These terms are only used to distinguish one element from another element. For example, a first element discussed below could be termed a second element, and similarly, a second element may also be termed a first element, without departing from the teachings of the present invention.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, components, and/or groups thereof but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs.

It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings.

The quantum Fourier transform (QFT) is perhaps the most versatile component of quantum algorithms. The QFT is the key ingredient of quantum algorithms such as Shor's factoring algorithm, quantum amplitude estimation² for Monte Carlo simulation and partial differential equation solver, for solving linear systems of equations, securities, to name a few. Therefore, reducing the cost of the QFT would be a pivotal task for the efficiency of many quantum algorithms.

Most quantum algorithms including QFT are implemented by quantum circuits. To carry out practical quantum algorithms, it is desirable that quantum circuits be implemented not only by universal but also by fault-tolerant quantum gates. The Clifford gates can be implemented fault-tolerantly at a low cost but they are not universal. Therefore non-Clifford gates are also required in addition to the Clifford gates to make the quantum circuits universal as well as fault-tolerant. Among the non-Clifford gates, the T gate (See the following Expression 1) is generally selected for universality.

As a result, The Clifford+T gate set is used as the standard elementary gate set. Unfortunately, in the case of the T gate, it is impossible to implement it in a fault-tolerant and transversal manner in contrast to the case of Clifford gates. To implement T gate fault-tolerantly, relatively expensive methods like state distillation are needed. Considering this, for the fault-tolerant quantum computing using Clifford+T gate set, the number of T gates (T-count) and the depth of T gates (T-depth) are regarded as the major costs of quantum circuits.

### Expression 1

$$T = ( \begin{matrix}1 & 0 \\ 0 & {e}^{i π / 4}\end{matrix} ) \qquad ( 1 )$$

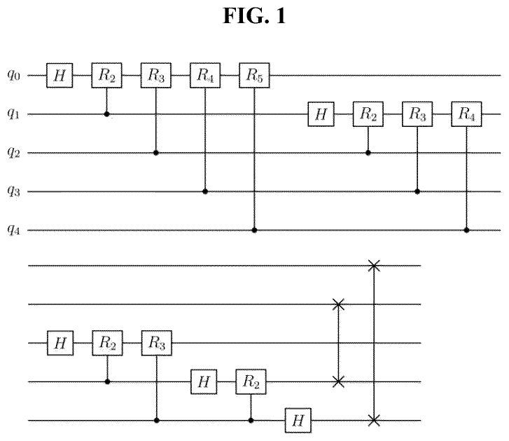

The standard n-qubit QFT circuit consists of n Hadamard (H) gates, n(n−1)/2 controlled-phase (C(Rₙ)) gates (See the following Expression 2), and [n/2] swap gates (See FIG. 1).

### Expression 2

$$C ( {R}_{n} ) = ( \begin{matrix}1 & 0 & 0 & 0 \\ 0 & 1 & 0 & 0 \\ 0 & 0 & 1 & 0 \\ 0 & 0 & 0 & {e}^{i π / {2}^{n - 1}}\end{matrix} ) \qquad ( 2 )$$

A swap gate can be synthesized using three controlled-not (CNOT) gates. For the C(Rx) gate, there are many proposed methods to decompose it in the previous studies. In general, the complete synthesis of a C(Rₙ) gate requires Rₙ gates (equivalent to the R_{z} gate up to the global phase) [See the following Exression3 and Expression 4].

### Expression 3

$${R}_{n} = ( \begin{matrix}1 & 0 \\ 0 & {e}^{i π / {2}^{n - 1}}\end{matrix} ) \qquad ( 3 )$$

### Expression 4

$${R}_{z} ( θ ) = {e}^{- i θ / 2} ( \begin{matrix}1 & 0 \\ 0 & {e}^{i θ}\end{matrix} ) \qquad ( 4 )$$

In general, complete decomposition of a general R_{z} gate into the standard elementary gate set is not possible. Therefore, for general R_{z} gate execution, gate synthesis up to the precision required for the executed algorithm is used, where the precision is defined as the spectral norm. To synthesize a general R gate to the precision ¿, The smallest known T-count is ˜1.15log₂(1/ε) by using the repeat-until-success (RUS) circuit.

There is another method to implement R_{z} gates, which is using quantum addition. However, this is rather a difficult method to apply to real quantum circuits. To use this method, The R_{z} gates must be layered with one depth, and the rotation angles of R_{z} gates in the layer must be all in the form of π/2^{k} or all in the form of −π/2^{k}. Here, k is a non-negative integer that increases sequentially from 0 and there must be no omission in the middle. Under these conditions, the method of implementing the R_{z} gates using addition is as follows. If each R, gate acting on the n qubit state is in the rotating angle of the form −π/2^{k}, where k is 0, 1, 2, . . . n, then we obtain a quantum state |ψ [symbol] which is given by

$$\vert ψ 〉 = \frac{1}{\sqrt{{2}^{n}}} {\sum }_{l = 0}^{{2}^{n} - 1} {e}^{2 π il / {2}^{n}} \vert l 〉 . \qquad ( 4 )$$

If the state of qubits to which we want to implement R_{z} gates is in a computational basis state |x), then our total state is in the tensor product state |x|ψ [symbol] . By adding |x [symbol] to the |ψ [symbol] , the resulting state of the process can be represented by the following form:

$$\vert x 〉 \frac{1}{\sqrt{{2}^{n}}} {\sum }_{l = 0}^{{2}^{n} - 1} {e}^{2 π il / {2}^{n}} \vert ( l + x ) mod {2}^{n} 〉 = {e}^{- 2 π ix / {2}^{n}} \vert x 〉 \frac{1}{\sqrt{{2}^{n}}} {\sum }_{l = 0}^{{2}^{n} - 1} {e}^{2 π il / {2}^{n}} \vert l 〉 \qquad ( 5 )$$

So, the state after the addition is e^{-2πix|2}^{ⁿ}|x [symbol] |ψ [symbol] which is the same state when we apply the R_{z} gate layer to the state |x [symbol] . For the n-qubit addition, the best-known result up to now requires ˜4n T-count with ˜2n T-depth. In the process, it may seem that R_{z} gate synthesis is not necessary, but it's not true. Because gate synthesis is required to prepare the state |ψ [symbol] . However, as shown above, the state (w) is conserved in the addition process and reusable. Therefore, if there are several identical layers of the R_{z} gates that satisfy the conditions under which addition is available, the method using addition is more efficient than gate synthesis.

The approximate quantum Fourier transform (AQFT) approximates QFT by discarding some C(Rₙ) gates with small angles. The AQFT has been studied for practical implementation of QFT because it is useful enough to implement quantum algorithms including Shor's factoring algorithm. The smallest known T-count and T-depth for the n-qubit QFT to the precision O(ε) using AQFT are ˜8nlog₂(n/ε) and ˜2nlog₂(n/ε) respectively by using quantum addition. Recently, one of the inventors proposed an efficient quantum circuit optimization protocol called quantum Karnaugh map (QKM). In this paper, we introduce a new implementation of the QFT using QKM and quantum addition, which halves the best-known T-count and T-depth results. The AQFT circuit in ref. 21 uses Toffoli gates (more precisely relative phase Toffoli gates), measurements, and classically controlled gates, to construct the R_{z} gate layers before applying addition. In our QFT circuit, the R_{z} gate layers are constructed without Toffoli gates by using a quantum circuit identity obtained from QKM. Using these methods, we can remove the cost to construct Toffoli gates that account for approximately half of the T-count in the method of ref. 21. The reduction of the T-depth is done by performing two additions at the same time by changing additions in sequence into parallel. In order to do this, we have used a new quantum circuit identity which is obtained by improving the result of ref. 23. As a result, we construct the QFT circuit with error O(ε) at a cost of ˜4nlog₂(n/ε) T-count and ˜nlog₂(n/ε) T-depth which is half of the best-known result.

### Results and Discussions

As a configuration of the quantum circuit, a 5-qubit QFT circuit will be described as an example.

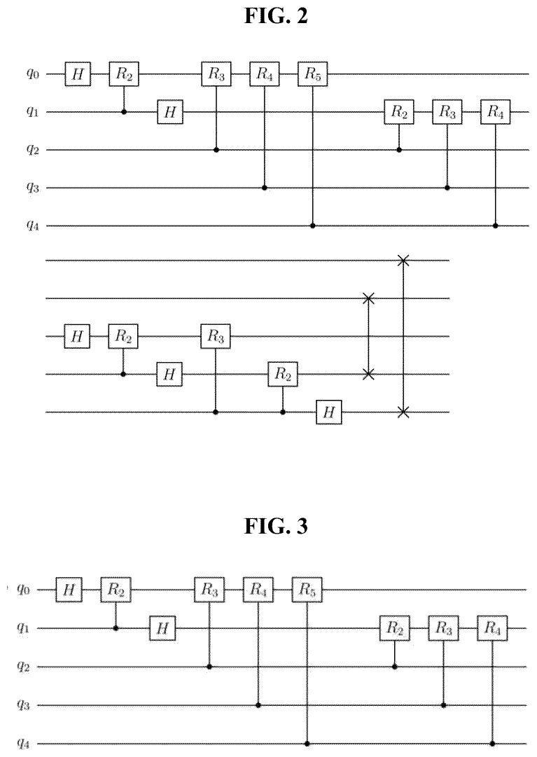

First, in the standard QFT circuit of FIG. 1, the H gate of even-numbered qubits is moved to the left as much as possible as shown in FIG. 1. That is, a Hadamard gate (H-gate) of an even-numbered qubits is moved to the earliest stage where there is no quantum entanglement with other qubits. Then, the QFT circuit is composed of sub-circuits of the form shown in FIG. 3. The circuit of FIG. 3 can be decomposed into the circuit of FIG. 4 in a form in which the R_{z} gate can be implemented using quantum addition.

In detail, the quantum circuit of FIG. 4 performs the following steps as shown in FIG. 4.

In a first step, the Hadamard gate is applied to the q₀ qubit, an R_{z}(π/4) gate is applied to the q₁ qubit, an R_{z}(3π/8) gate is applied to q₂ qubits, an R_{z}(3π/16) gate is applied to q₃ qubits, and an R_{z}(3π/32) gate is applied to q₄ qubits.

In a second step, a CNOT gate is applied to the q₀ gate, based on the q₁ qubit after the first step.

In a third step, an R_{z}(−π/4) gate is applied to the q₀ qubit after the second step.

In a fourth step, a CNOT gate is applied to the q₀ gate, based on the q₁ qubit after the third step.

In a fifth step, a Hadamard gate is applied to the qu qubit after the fourth step.

In a sixth step, a CNOT gate is applied to q₁ to q₄ qubits, based on the q₀ qubits after fifth step.

In a seventh step, an R_{z}(−π/8) gate is applied to the q₂ gate after the sixth step, R_{z}(−π/16) gate is applied to the q₃ gate after the sixth step, and R_{z}(−π/32) gate is applied to the q₄ gate after the sixth step.

In an eighth step, a CNOT gate is applied to q₁ to q₄ qubits, based on the q₀ qubits after the seventh step.

In a ninth step, a CNOT gate is applied to q₂ to q₄ qubits, based on the q₁ qubit after the eighth step.

In a tenth step, an R_{z}(−π/4) gate is applied to the q₂ gate after the ninth step, an R_{z}(−π/8) gate is applied to the q₃ gate after the ninth step, and an R_{z}(−π/16) gate is applied to the q₄ gate after the ninth step.

In eleventh step, a CNOT gate is applied to q₂ to q₄ qubits, based on the q₁ qubit after the tenth step; and

In twelfth step, an R_{z}(15π/32) gate is applied to the q₀ qubit after the eighth step, and applying an R_{z} (7π/16) gate to the qu qubit after the eleventh step.

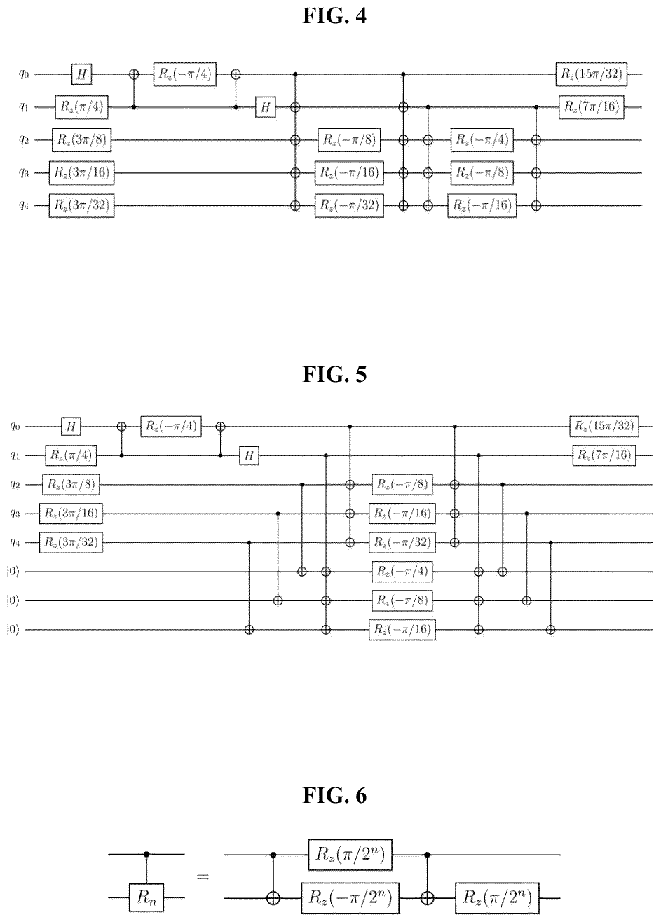

The circuit of FIG. 4 can be replaced with the circuit of FIG. 5 with reduced number of R_{z} gate layers by using ancilla qubits initially in the |0>state, where two R_{z} gate layers are performed in parallel.

A quantum circuit that has gone through the step of reducing the number of R_{z} gate layers using ancilla qubits, as shown in FIG. 4, can be configured to perform each step below.

In a first step, a Hadamard gate is applied to the q₀ qubit, an R_{z}(π/4) gate is applied to the q₁ qubit, an R_{z}(3π/8) gate is applied to q₂ qubits, an R_{z}(3π/16) gate is applied to q₃ qubits, and an R_{z}(3π/32) gate is applied to q₄ qubits.

In a second step, a CNOT gate is applied to the q₀ gate, based on the q₁ qubit after the first step.

In a third step, an R_{z}(−π/4) gate is applied to the q₀ qubit after the second step.

In a fourth step, a CNOT gate is applied to the q₀ gate, based on the q₁ qubit after the third step.

In a fifth step, a Hadamard gate is applied to the q₁ qubit after the fourth step, and a CNOT gate is applied to a third ancilla qubit |0>, based on the q₄ qubits after the first step.

In a sixth step, CNOT gate is applied to a second ancilla qubit |0>, based on the q₃ qubit after the first step.

In a seventh step, a CNOT gate is applied to a first ancilla qubit |0>, based on the q₂ qubits after the first step.

In an eighth step, a CNOT gate is applied to the first to third ancilla qubits, based on the q₁ qubit after the fifth step.

In a ninth step, a CNOT gate is applied to q₂ to qu qubits, based on the q₀ qubits after the fourth step.

In a tenth step, an R_{z}(−π/8) gate is applied to the q₂ qubit, an R_{z}(−π/16) gate is applied to the q₃ qubit, an R_{z}(−π/32) gate is applied to the q₄ qubit, an R_{z}(−π/4) gate is applied to the first ancilla qubit, an R_{z}(−π/8) gate is applied to the second ancilla qubit, and an R_{z}(−π/16) gate is applied to the third ancilla qubit.

In an eleventh step, a CNOT gate is applied to the q₂, q₃, and q₄ qubits, based on the q₀ qubit.

In a twelfth step, a CNOT gate is applied to the first to third ancilla qubits, based on the q₁ qubit.

In a thirteenth step, a CNOT gate is applied to the first ancilla qubit, based on the q₂ qubit.

In a fourteenth step, a CNOT gate is applied to the second ancilla qubit, based on the q₃ qubit.

In a fifteenth step, a CNOT gate is applied to the third ancilla qubit, based on the q₄ qubit.

In a sixteenth step, an R_{z}(15π/32) gate is applied to the q₀ qubit, and applying R_{z}(7π/16) gate to the q₁ qubit.

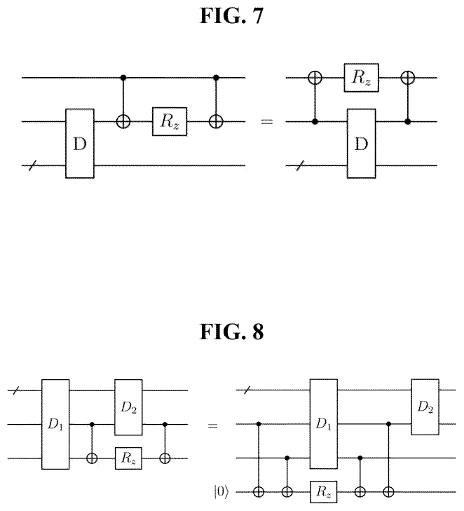

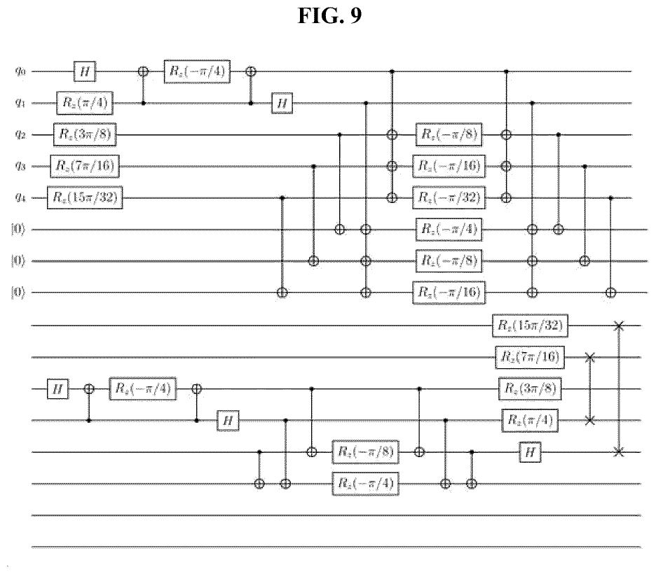

From FIG. 3 to FIG. 4, we apply circuit identity in FIG. 6, and use the fact that an R_{z} gate commutes a circuit that has a diagonal matrix form on a computational basis. And by applying the circuit identity FIG. 7, the circuit in FIG. 4 can be made. From FIG. 4 to FIG. 5, we apply the circuit identity in FIG. 8 to FIG. 4 successively. The circuit identities in FIGS. 6 to 8 can be obtained by applying QKM. The idea of the circuit identity in FIG. 8 is inspired by the theorem 4.1 in ref. 23. Among the R_{z} gate layer in FIG. 5, the first layers can be moved to the very first of the QFT circuit and the last R_{z} gate layers can be moved to the very end of the QFT circuit. As a result, we can implement the QFT circuit with ˜n/2 R_{z} gate layers and ˜n/2 R_{z}(−π/4) gates as shown in FIG. 9.

That is, the 5-qubit QFT circuit shown in FIG. 9 is configured to perform each step below.

In a first step, a Hadamard gate is applied to q₀ qubit, applying an R_{z}(π/4) gate to the q₁ qubit, an R_{z}(3π/8) gate is applied to q₂ qubit, an R_{z}(3π/16) gate is applied to q₃ qubit, and an R_{z}(3π/32) gate is applied to q₄ qubit.

In a second step, a CNOT gate is applied to the q₀ gate, based on the q₁ qubit after the first step.

In a third step, an R_{z}(−π/4) gate is applied to the q₀ qubit after the second step.

In a fourth step, a CNOT gate is applied to the q₀ gate, based on the q₁ qubit after the third step.

In a fifth step, a Hadamard gate is applied to the q₁ qubit after the fourth step, and a CNOT gate is applied to a third ancilla qubit |0>, based on the q₄ qubits after the first step.

In a sixth step, a CNOT gate is applied to a second ancilla qubit |0>, based on the q₃ qubit after the first step.

In a seventh step, a CNOT gate is applied to a first ancilla qubit |0>, based on the q₂ qubits after the first step.

In an eighth step, a CNOT gate is applied to the first to third ancilla qubits, based on the q₁ qubit after the fifth step.

In a ninth step, a CNOT gate is applied to q₂ to q₄ qubits, based on the q₀ qubits after the fourth step.

In a tenth step, an R_{z}(−π/8) gate is applied to the q₂ qubit, an R_{z}(−π/16) gate is applied to the q₃ qubit, an R_{z}(−π/32) gate is applied to the q₄ qubit, an R_{z}(−π/4) gate is applied to the first ancilla qubit, an R_{z}(−π/8) gate is applied to the second ancilla qubit, and an R_{z}(−π/16) gate is applied to the third ancilla qubit.

In an eleventh step, a CNOT gate is applied to the q₂, q₃, and q₄ qubits, based on the q₀ qubit.

In a twelfth step, a CNOT gate is applied to the first to third ancilla qubits, based on the q₁ qubit. In a thirteenth step, a CNOT gate is applied to the first ancilla qubit, based on the q₂ qubit.

In a fourteenth step, a CNOT gate is applied to the second ancilla qubit, based on the q₃ qubit.

In a fifteenth step, a CNOT gate is applied to the third ancilla qubit, based on the q₄ qubit.

In a sixteenth step, a Hadamard gate is applied to the q₂ qubit.

In a seventeenth step, a CNOT gate is applied to the q₂ qubit, based on the q₃ qubit.

In an eighteenth step, an R_{z}(−π/4) gate is applied to the q₂ qubit.

In a nineteenth step, a CNOT gate is applied to the q₂ qubit, based on the q₃ qubit.

In a twentieth step, a Hadamard gate is applied to the q₃ qubit.

In a twenty first step, a CNOT gate is applied to the first ancilla qubit, based on the q₄ qubit.

In a twenty second step, a CNOT gate is applied to the first ancilla qubit, based on the q₃ qubit.

In a twenty third step, a CNOT gate is applied to the q₄ qubit, based on the q₂ qubit.

In a twenty fourth step, an R_{z}(−π/8) gate is applied to the q₄ qubit, and an R_{z}(−π/4) gate is applied to the first ancilla qubit.

In a twenty fifth step, a CNOT gate is applied to the qu qubit, based on the q₂ qubit.

In a twenty sixth step, a CNOT gate is applied to the first ancilla qubit, based on the q₃ qubit.

In a twenty seventh step, a CNOT gate is applied to the first ancilla qubit, based on the q₄ qubit.

In a twenty eighth step, an R_{z}(15π/32) gate is applied to the q₀ qubit, an R_{z}(7π/16) gate is applied to the qu qubit, an R_{z}(3π/8) gate is applied to the q₂ qubit, an R_{z}(π/4) gate is applied to the q₃ qubit, and a Hadamard gate is applied to the q₄ qubit.

In a twenty ninth step, the qu qubit and the q₃ qubit are swapped.

In a thirtieth step, q₀ and q₄ qubits are swapped.

FIG. 1 is a standard a 5-qubit QFT circuit. FIG. 2 is a 5-qubit QFT circuit with moved Hadamard (H) gates. The H gates of even-numbered qubits in FIG. 1 are moved to the left of the circuit as far as possible.

FIGS. 3 to 5 are decompositions of subcircuits of the quantum Fourier transform (QFT).

FIG. 3 is a subcircuit of the QFT circuit in FIG. 2. FIG. 4 is a sub-circuit decomposition, and this circuit is the same as FIG. 3. And the R_{z} gate layers except the first and last layers are in the form in which addition can be applied. This accounts for the T-count reduction. FIG. 5 is a sub-circuit decomposition that two R_{z} gate layers are in a single layer. This accounts for the T-depth reduction. This circuit is also the same as FIG. 3 and FIG. 4 except using ancilla qubits that are in the state |0 [symbol] initially.

FIGS. 6 to 8 are circuit identities.

In detail, FIG. 6 is a decomposition of controlled-R, gate. FIG. 7 is a circuit identity used to decompose the circuit in FIG. 3 into the circuit in FIG. 4. In FIG. 7, D is a circuit with diagonal matrix form in the computational basis. With this circuit identity, we can make the required R, gate layers without using Toffoli gates. This accounts for the T-count reduction. The quantum Karnaugh map is used to obtain the circuit indenty. FIG. 8 is a circuit identity used to decompose the circuit in FIG. 4 into the circuit in FIG. 5. D₁ and D2 are circuits with diagonal matrix form in the computational basis. This circuit identity can make two R_{z} gate layers in into a single layer, which accounts for T-depth reductions.

FIG. 9 is a decomposed quantum Fourier transform (QFT) circuit according to an embodiment of the present invention. There are ˜n/2 R_{z} gate layers and ˜n/2 R_{z}(−π/4) gates in decomposed QFT circuit. This circuit is executed by using additions, which reduces the number of T gates. Except for the first and the last R_{z} gate layers, R_{z} gate layers can be implemented in parallel, which effectively halves the T-depth.

So far, it is a perfect QFT implementation without any approximation. Before the approximation, we note that the R_{z} gates in the first and last Ra gate layers have the angle (2^{k-1}−1)π/2^{k}, where k is a non-negative integer (See FIG. 9). As a next step, we would like to modify the first and the last R_{z} gate layer of the circuit in FIG. 9 into the same form as the rest of the R_{z} gate layers which include R_{z} gates with the angle −π/2^{k}, then each R_{z} gate in the first and last R_{z} gate layer is replaced by an R_{z}(π/2) gate (S gate) with an R_{z}(−π/2^{k}) gate.

Next, we proceed with the approximation. All the R_{z} gates with an absolute value of the rotation angle less than π/2^{b} are discarded, where b is a positive integer related to the precision. As a result, up to 2(b−1) R_{z} gates remain in each R_{z} gate layer.

Finally, we apply quantum addition to reduce the required T-count. To do that, the R_{z} gate layers are required to satisfy the conditions described before. We show that additional R_{z}(−π), R_{z}(−π/2), and R_{z}(−π/4) gates (Z⁻¹, S⁻¹, and T⁻¹ gates) are needed to implement R_{z} gates by applying quantum addition. So we add the those required gates and additionally R_{z}(π), R_{z}(π/2), and R_{z}(π/4) gates (Z, S, and T gates) to make overall procedure unity or identity. This process raises T-count by [n/2]. To implement quantum addition, we also need to prepare the two of the state |ψ [symbol] .

$$\vert ψ 〉 = \frac{1}{\sqrt{{2}^{b + 1}}} {\sum }_{l = 0}^{{2}^{b + 1} - 1} {e}^{2 π il / {2}^{n}} \vert l 〉 \qquad ( 6 )$$

Now, we reduce the T-depth of the QFT by executing two quantum additions in parallel. So we have to prepare two |ψ [symbol] s. In the case of R_{z} gate layers in which the absolute value of the smallest angle of R_{z} gates is π/2^{r}, where r is a positive integer smaller than b, (r+1) qubit addition is applied. In the process, the required state |ψᵣ [symbol] does not need to be prepared separately, because the corresponding part of |ψ [symbol] can be used.

$$\vert {ψ}_{r} 〉 = \frac{1}{\sqrt{{2}^{r + 1}}} {\sum }_{l = 0}^{{2}^{r + 1} - 1} {e}^{2 π il / {2}^{n}} \vert l 〉 \qquad ( 7 )$$

### Error analysis

The error between quantum circuits U and V or the precision of implementation of U instead of V (error(U, V)) is defined as the spectral norm of (U−V) and the accumulative error between U₁ U₂ . . . Uₘ and V₁ V₂ . . . Vₘ is at most Σᵢ₌₁^{m}error(Uᵢ, Vᵢ)⁸. For some positive integer p, if one R_{z}(−π/2^{p}) gate is discarded, then the error is ∥1−e^{iπ/2}^{^{p}}∥ and it is smaller than π/2^{p}. So, the error of the first R_{z} gate layer in our approximate QFT circuit is at most Σ_{p=b+1}ⁿπ/2^{p} and it is smaller than π/2^{b}. Here ∥⋅∥ denotes l₂ norm.

Among the R_{z} layers which is the object of a single addition, the largest number of R_{z} gates are discarded in the first layer and the last layer. The approximation error of the first R_{z} gate layer is the greatest among the approximation errors of the R_{z} gate layers. The upper bound of the error caused by the discarded R_{z} gates is π(n−b+2)/2^{b}. In the process, we choose b as log₂(n/ε). Then, the error caused by discarding some R_{z} gates is lower than πε(n−b+2)/n. If b is greater than 2, the error is less than πε.

The total error is dependent not only on the error caused by discarding R_{z} gates but also on the error caused by R_{z} gate synthesis. Gate synthesis is necessary for the preparation of the state |ψ [symbol] which is used for addition. The state |ψ [symbol] can be obtained by executing a Hadamard gate and the R_{z}(π/2^{k}) gate on the kth qubit in the (b+1) qubits which are initially all in the state |0 [symbol] .

Among the required (b+1) R_{z} gates, Z, S, and T gates do not need to be synthesized. So 2(b−2) R_{z} gates are needed to be synthesized for obtaing two |ψ [symbol] states. If the RUS method is used, the required T-count to synthesize an R_{z} gate using the standard elementary gates to the precision ε is ˜1.15 log₂(1/ε), which is the smallest known so far¹⁵. If we choose the upper bound of the precision of gate synthesis as ε/2b, The error caused by the gate synthesis is lower than ε(b−2)/b which is lower than ε. The total error that includes both errors from the discarding R_{z} gates and the gate synthesis is lower than ε(π+1). Then, the error of our approximation for QFT is O(ε).

The required number of T gates of our process is divided into three parts: The first one is the number of T gates required for addition. The second one is the number of T gates required for R_{z} gate synthesis. The third one is the n T gates that quantum addition is not applied.

For m-qubit addition, the required T-count is 4(m−1) which is the smallest to the best of our knowledge. Since we apply (b+1) or smaller number of qubit addition n times for the implementation of our approximate n-qubit QFT to the precision ε, the T-count required for addition is smaller than 4nlog₂(n/ε). For the R_{z} gate synthesis, the required T-count is ˜2.3(b−2)log₂(2b/ε), because there are 2(b−2) R_{z} gates that are required for the gate synthesis to the precision ε/2b.

As a result, the total T-count is ˜4nlog₂(n/ε)+n+2.3(b−2)log₂(2b/ε) for n-qubit QFT to the precision O(ε). And in this case, The T-depth is ˜nlog₂(n/ε)+n+2.3log₂(2b/ε). The term nlog₂(n/ε) is from the parallel addition. This is because the 2b T-depth is required for a (b+1) qubit addition. The term 2.3log₂(2b /ε) is from the gate synthesis. The reason why the factor 2(b−2) doesn't have to be multiplied is that each gate synthesis can be implemented in parallel. Our results and comparison with the previous studies are shown in Table. 1.

TABLE 1
Result and comparison of T-count and T-depth of the QFT.

| | T-count | T-depth |
|---|---|---|
| Ref. 14 | 1.15n(log₂ n)log₂(nlog₂n) + O(nlogn) | 1.15n(log₂ n)log₂(nlog₂n) + O(n) |
| Ref. 20 | 8nlog₂n + O((logn)log(logn)) | 2nlog₂n + O(log(logn)) |
| Ours | 4nlog₂n + O(n) | nlog₂n + O(n) |

For the convenience of comparison, we omit the dependence on precision in Table 1.

### NISQ Implementation of QFT

In this section, we implement a toy model of quantum phase estimation (QPE) based on QFT on the IonQ device using Amazon Braket to see how well QFT can be implemented on the NISQ²⁴ devices. Our main result is for fault-tolerant quantum computing and the circuit we construct has a serious disadvantage for NISQ devices compared to basic circuit decomposition in ref. 12 because we require additional quantum gates and ancilla qubits. For this reason, we use a QFT circuit decomposed only using circuit identities FIG. 3a and FIG. 3b, not FIG. 3c when implementing QPE.

IonQ device is a quantum computer using trapped 171Yb⁺ ions. It has 11 qubits and the qubits of the device are fully connected. For the IonQ device, the fidelity of the single-qubit gates is 0.9955 on average and the fidelity of the two-qubit gates is 0.9614 on average. The QPE is an algorithm to find the eigenvalue of a unitary matrix U using the corresponding eigenvector |u [symbol] ⁸. We define the matrix U and the eigenvector |u [symbol] as follows.

$$U = ( \begin{matrix}1 & 0 \\ 0 & {e}^{2 π i φ}\end{matrix} ) , \vert u 〉 = ( \begin{matrix}0 \\ 1\end{matrix} ) \qquad ( 8 )$$

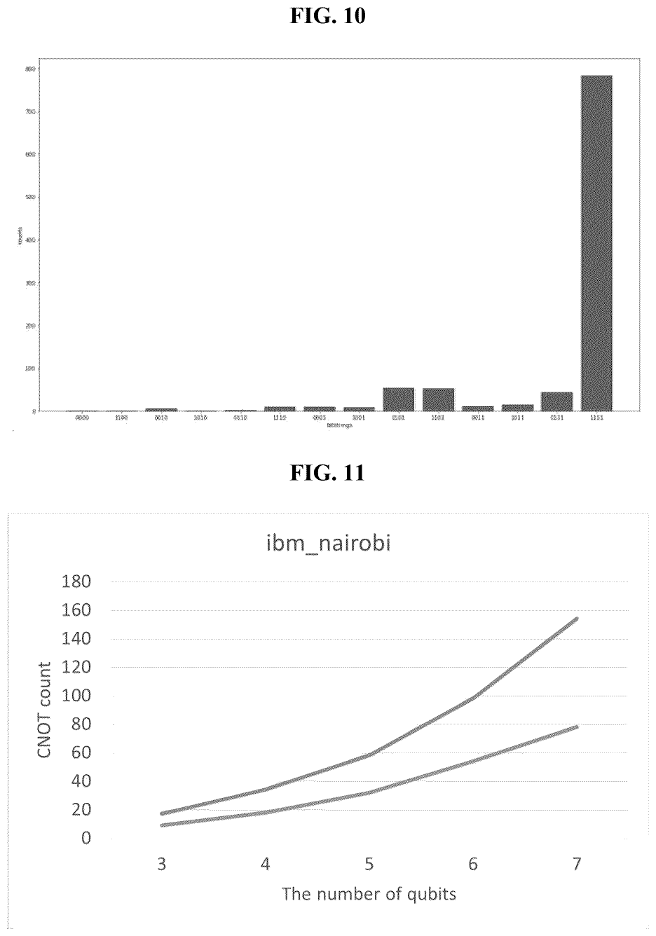

We implemented QPE by choosing φ as (0,1/8,2/8 . . . , 7/8) for 3-qubit QPE, (0,1/16,2/16 . . . , 1.5/16) for 4-qubit QPE, and (0,1/32,2/32 . . . , 31/32) for 5-qubit QPE. And the success rate was measured by executing 1000 times for each φ. As a result, we were able to get the right result on average ˜77%, ˜48%, and ˜11% for 3-, 4-, and 5-qubit QPE. For 3- and 4-qubit QPE, we could find the right answer by using a majority vote. From the 5-qubit QPE, it is found that there are cases that the result of the majority vote is not always the correct answer (see Table 2). An example of the QPE implementation is shown in FIG. 10 for 3-qubit case.

### 3- to 5-Qubit Quantum Phase Estimation (QPE)

When implementing 3- to 5- QPE, we chose φ as (0,1/8, 2/8 . . . , 7/8) for 3-qubit QPE, (0,1/16,2/16 . . . , 15/16) for 4-qubit QPE, and (0,1/32,2/32 . . . , 31/32) for 5-qubit QPE. For each φ, we ran it 1000 times respectively. In the table, the average count is the average of the number of times the correct answer was found out of 1000 runs and the success rate is the probability of finding the correct value when using a majority vote.

TABLE 2

| The number of qubits | Average count | Success rate (%) |
|---|---|---|
| 3 | 769.75 | 100 |
| 4 | 475.19 | 100 |
| 5 | 110.66 | 87.5 |

FIG. 10 is an example of the result of the implementation of quantum phase estimation (QPE) on the IonQ device. It is a result of a 3-qubit QPE on the IonQ device. The x-axis is the result of measurement (bitstring) and the y-axis is the measurement count. φ was 7/8. We found the right answer by using a majority vote.

In summary, we introduced a new approximation circuit of the QFT to the precision of O(ε). The leading order of T-count and T-depth are 4nlog₂(n/ε) and nlog₂(n/ε), respectively. Up to now, the leading order of 8nlog₂(n/ε) T-count with 2nlog₂(n/ε) T-depth is the best-known result for least T-count and T-depth implementation of the QFT to the precision of O(ε). Therefore, our results show approximately half of the best-known T-count and T-depth of the QFT to the precision O(ε). We implemented 3- to 5-qubit QFT on a NISQ device. Our results may accelerate the fault-tolerant implementation of QFT and provide useful insight for the near term NISQ applications.

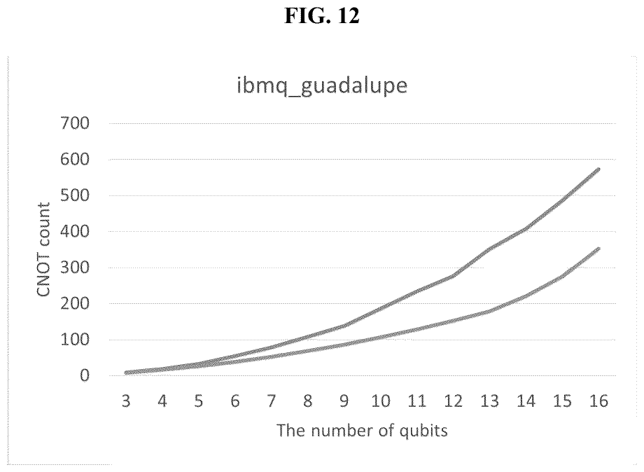

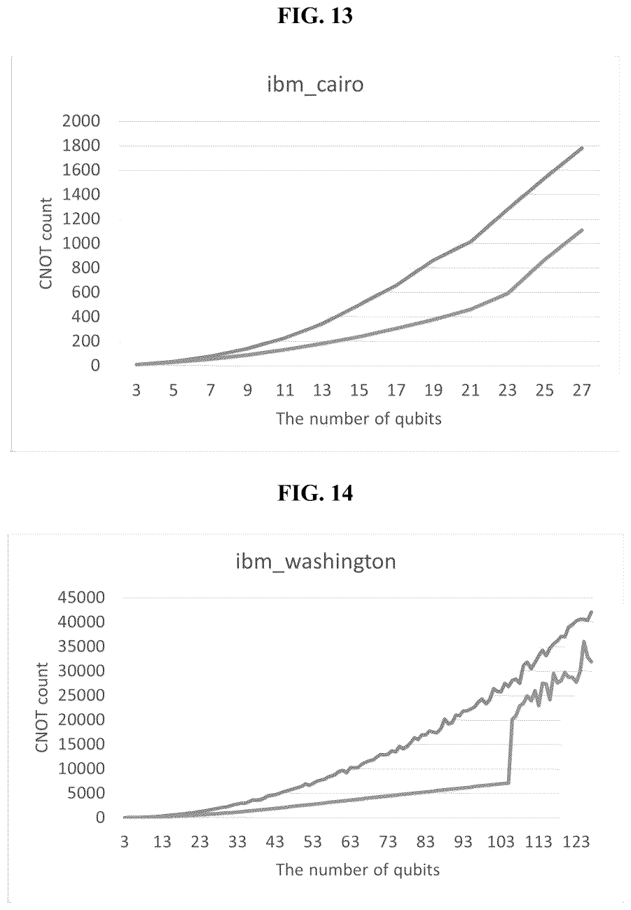

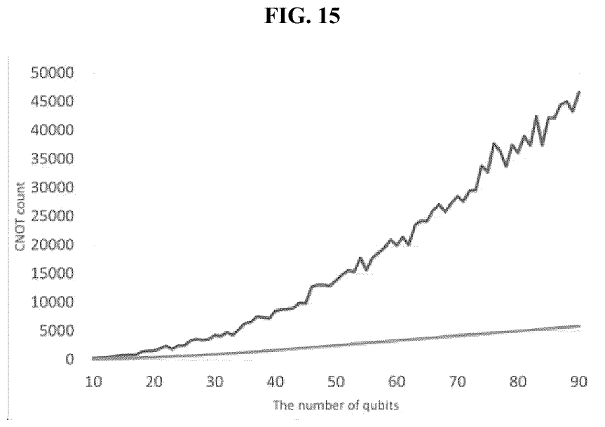

FIG. 11 is a graph showing simulation results showing the number of CNOTs for a 7-qubit quantum computer using a Falcon r5.11H processor, FIG. 12 is a graph showing simulation results showing the number of CNOTs for a 16-qubit quantum computer using a Falcon r4P processor, FIG. 13 is a graph showing simulation results showing the number of CNOTs for a 27-qubit quantum computer using a Falcon r5.11 processor, FIG. 14 is a graph showing simulation results showing the number of CNOTs for a 27-qubit quantum computer using an Eagle r1 processor, and FIG. 15 is a graph showing simulation results showing the number of CNOTs for 10 to 90 qubit quantum computers.

In FIGS. 11 to 15 the x-axis is the number of qubits of an n-qubit QFT, and the y-axis is the number of required CNOTs. As shown, it can be confirmed that the method of forming a quantum Fourier transform circuit according to the present invention and the quantum Fourier transform circuit according to the method greatly reduce the number of CNOTs.

It will be apparent to those skilled in the art that various modifications and variation may be made in the present invention without departing from the spirit or scope of the invention. Thus, it is intended that the present invention cover the modifications and variations of this invention provided they come within the scope of the appended claims and their equivalents.

What is claimed is:

1. A method of forming a Quantum Fourier Transform (QFT) circuit comprising:
moving Hadamard gate (H-gate) of an even-numbered qubits to the earliest stage where there is no quantum entanglement with other qubits, in a standard n (n is a natural number greater than or equal to 5) qubit QFT;
decomposing quantum circuit into a form in which an R_{z} gate is implemented, using quantum addition; and
reducing a number of R_{z} gate layers using ancilla qubits.

2. The method of claim 1, wherein the form in which the R_{z} gate is implemented, performs:
in a first step, applying a Hadamard gate to the q₀ qubit, applying an R_{z}(π/4) gate to the q₁ qubit, and applying an R_{z}(3π/2^{k+}1) gate to qₖ qubits (k is a natural number greater than or equal to 5 and less than or equal to n−1);
in a second step, applying a CNOT gate to the q₀ gate, based on the q₁ qubit after the first step;
in a third step, applying an R_{z} (−π/4) gate to the q₀ qubit after the second step;
in a fourth step, applying a CNOT gate to the q₀ gate, based on the q₁ qubit after the third step;
in a fifth step, applying a Hadamard gate to the q₁ qubit after the fourth step;
in a sixth step, applying a CNOT gate to q₁ to q(n−1) qubits, based on the q₀ qubits after fifth step;
in a seventh step, applying an R_{z}(−π/2^{l+1}) gate to the q₁ gate after the sixth step (1 is a natural number greater than or equal to 5 and less than or equal to n−1);
in an eighth step, applying a CNOT gate to q₁ to q(n−1) qubits, based on the q₀ qubits after the seventh step;
in a ninth step, applying a CNOT gate to q₂ to q(n−1) qubits, based on the qu qubit after the eighth step;
in a tenth step, applying an R_{z}(−π/2¹) gate to the q₁ gate after the ninth step (1 is a natural number greater than or equal to 5 and less than or equal to n−1);
in eleventh step, applying a CNOT gate to q₂ to q(n−1) qubits, based on the q₁ qubit after the tenth step; and
in twelfth step, applying an R_{z}(15π/32) gate to the q₀ qubit after the eighth step, and applying an R_{z} (7π/16) gate to the q₁ qubit after the eleventh step, wherein
$${R}_{Z} ( θ ) = {e}^{- i θ / 2} ( \begin{matrix}1 & 0 \\ 0 & {e}^{i θ}\end{matrix} )$$

3. The method of claim 2, wherein a quantum circuit with reduced number of R_{z} gate layers using ancilla qubits, performs:
in a first step, applying a Hadamard gate to the q₀ qubit, applying an R_{z}(π/4) gate to the q₁ qubit, and applying an R_{z}(3π/2^{k+1}) gate to qₖ qubits (k is a natural number greater than or equal to 5 and less than or equal to n−1);
in a second step, applying a CNOT gate to the q₀ gate, based on the qu qubit after the first step;
in a third step, applying an R_{z}(−π/4) gate to the q₀ qubit after the second step;
in a fourth step, apply a CNOT gate to the q₀ gate, based on the q₁ qubit after the third step;
in a fifth step, applying a Hadamard gate to the q₁ qubit after the fourth step, and applying a CNOT gate to a third ancilla qubit |0>, based on the q₄ qubits after the first step;
in a sixth step, applying a CNOT gate to a second ancilla qubit |0>, based on the q₃ qubit after the first step;
in a seventh step, applying a CNOT gate to a first ancilla qubit |0>, based on the q₂ qubits after the first step;
in an eighth step, applying a CNOT gate to the first to third ancilla qubits, based on the q₁ qubit after the fifth step;
in a ninth step, applying a CNOT gate to q₂ to q₄ qubits, based on the q₀ qubits after the fourth step;
in a tenth step, applying an R_{z}(−π/8) gate to the q₂ qubit, applying an R_{z}(−π/16) gate to the q₃ qubit, applying an R_{z}(−π/32) gate to the q₄ qubit, applying an R_{z}(−π/4) gate to the first ancilla qubit, applying an R_{z}(−π/8) gate to the second ancilla qubit, and applying an R_{z}(−π/16) gate to the third ancilla qubit;
in an eleventh step, applying a CNOT gate to the q₂, q₃, and q₄ qubits, based on the q₀ qubit;
in a twelfth step, applying a CNOT gate to the first to third ancilla qubits, based on the q₁ qubit;
in a thirteenth step, applying a CNOT gate to the first ancilla qubit, based on the q₂ qubit;
in a fourteenth step, applying a CNOT gate to the second ancilla qubit, based on the q₃ qubit;
in a fifteenth step, applying a CNOT gate to the third ancilla qubit, based on the q₄ qubit;
in a sixteenth step, applying an R_{z}(15π/32) gate to the q₀ qubit, and applying R_{z}(7π/16) gate to the q₁ qubit.

4. An n-qubits Quantum Fourier Transform circuit that performs following steps (n is a natural number greater than or equal to 5),
in a first step, applying a Hadamard gate to q₀ qubit, applying an R_{z}(π/4) gate to the q₁ qubit, applying an R_{z}(3π/2^{k+1}) gate to qₖ qubits (k is a natural number greater than or equal to 5 and less than or equal to n−1);
in a second step, applying a CNOT gate to the q₀ gate, based on the qu qubit after the first step;
in a third step, applying an R_{z}(−π/4) gate to the q₀ qubit after the second step;
in a fourth step, applying a CNOT gate to the q₀ gate, based on the q₁ qubit after the third step;
in a fifth step, applying a Hadamard gate to the q₁ qubit after the fourth step, and applying a CNOT gate to a third ancilla qubit |0>, based on the q₄ qubits after the first step;
in a sixth step, applying a CNOT gate to a second ancilla qubit |0>, based on the q₃ qubit after the first step;
in a seventh step, applying a CNOT gate to a first ancilla qubit |0>, based on the q₂ qubits after the first step;
in an eighth step, applying a CNOT gate to the first to third ancilla qubits, based on the q₁ qubit after the fifth step;
in a ninth step, applying a CNOT gate to q₂ to qu qubits, based on the q₀ qubits after the fourth step;
in a tenth step, applying an R_{z}(−π/8) gate to the q₂ qubit, applying an R_{z}(−π/16) gate to the q₃ qubit, applying an R_{z}(−π/32) gate to the q₄ qubit, applying an R_{z}(−π/4) gate to the first ancilla qubit, applying an R_{z}(−π/8) gate to the second ancilla qubit, and applying an R_{z}(−π/16) gate to the third ancilla qubit;
in an eleventh step, applying a CNOT gate to the q₂, q₃, and q₄ qubits, based on the q₀ qubit;
in a twelfth step, applying a CNOT gate to the first to third ancilla qubits, based on the q₁ qubit;
in a thirteenth step, applying a CNOT gate to the first ancilla qubit, based on the q₂ qubit;
in a fourteenth step, applying a CNOT gate to the second ancilla qubit, based on the q₃ qubit;
in a fifteenth step, applying a CNOT gate to the third ancilla qubit, based on the q₄ qubit;
in a sixteenth step, applying a Hadamard gate to the q₂ qubit;
in a seventeenth step, applying a CNOT gate to the q₂ qubit, based on the q₃ qubit;
in an eighteenth step, applying an R_{z}(−π/4) gate to the q₂ qubit;
in a nineteenth step, applying a CNOT gate to the q₂ qubit, based on the q₃ qubit;
in a twentieth step, applying a Hadamard gate to the q₃ qubit;
in a twenty first step, applying a CNOT gate to the first ancilla qubit, based on the q₄ qubit;
in a twenty second step, applying a CNOT gate to the first ancilla qubit, based on the q₃ qubit;
in a twenty third step, applying a CNOT gate to the q₄ qubit, based on the q₂ qubit;
in a twenty fourth step, applying an R_{z}(−π/8) gate to the q₄ qubit, and applying an R_{z}(−π/4) gate to the first ancilla qubit;
in a twenty fifth step, applying a CNOT gate to the q₄ qubit, based on the q₂ qubit;
in a twenty sixth step, applying a CNOT gate to the first ancilla qubit, based on the q₃ qubit;
in a twenty seventh step, applying a CNOT gate to the first ancilla qubit, based on the q₄ qubit;
in a twenty eighth step, applying an R_{z}(15π/32) gate to the q₀ qubit, applying an R_{z}(7π/16) gate to the q₁ qubit, applying an R_{z}(3π/8) gate to the q₂ qubit, applying an R_{z}(π/4) gate to the q₃ qubit, and applying a Hadamard gate to the q₄ qubit;
in a twenty ninth step, swapping the q₁ qubit and the q₃ qubit; and
in a thirtieth step, swapping q₀ and q₄ qubits, wherein
$${R}_{Z} ( θ ) = {e}^{- i θ / 2} ( \begin{matrix}1 & 0 \\ 0 & {e}^{i θ}\end{matrix} )$$
